(19) United States
(12) Patent Application Publication
(10) Pub. No.: US 2005/0164726 A1
(43) Pub. Date: Jul. 28, 2005

(54) System and method of providing push-to-talk service in a mobile communication system

(75) Inventor: In-Dong Yeo, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/051,622

(22) Filed: Jan. 27, 2005

(30) Foreign Application Priority Data
Jan. 28, 2004 (KR) 2004-5356

(51) Int. Cl. H04Q 7/20

(52) U.S. Cl. 455/518

(57) ABSTRACT

A system and method of providing a Push-To-Talk (PTT) service in a mobile communication system are provided. Particularly, a new service option for the PTT service is defined and set before a call setup between a mobile station (MS) and a base station (BS) in order to allow the MS and the BS to recognize a PTT call. Upon receipt of an origination message including the service option of the PTT service from the MS, the BS establishes a Radio Link Protocol (RLP) with the MS and establishes a Point-to-Point Protocol (PPP) session to provide the PTT service in packet data to the MS. PRIORITY

This application claims the benefit under 35 U.S.C. § 119(a) to an application entitled “Method of Providing Push-to-Talk Service in a Mobile Communication System” filed in the Korean Intellectual Property Office on Jan. 28, 2004 and assigned Serial No. 2004-5356, the entire contents of which are incorporated herein by reference.

### BACKGROUND OF THE INVENTION

1. Field of the Invention

The present invention relates to a system and method of providing a Push-to-Talk (PTT) service. More particularly, the present invention relates to a system and method of providing a PTT service in a mobile communication system.

2. Description of the Related Art

A core network (CN) in a mobile communication system is rapidly evolving to an All-IP network because the All-IP network facilitates implementation of various applications. Because many service providers are now considering migration to an IP Multimedia Subsystem (IMS), a variety of associated issues are being addressed.

One of the most popular services over the IMS network is the PTT service. The PTT service provides a walkie-talkie feature that allows customers to communicate with a called party via a simple keystroke. Besides, the PTT service enables group calling, such as conference calls on a wired phone, as well as one-to-one calls. Although a conventional mobile terminal places a call, not knowing whether the other party is available, as implied from its name “instant messaging (IM)”, the PTT service displays the chat names or nicknames of users available to participate in a walkie-talkie call, like a MSN™ messenger, which is attractive mainly to youth. As compared to a conventional mobile phone call, the PTT service boasts a short call waiting time and ease of use. The Open Mobile Alliance (OMA) is working to standardize the PTT service and it is common knowledge that the 3^{rd} Generation Partnership Project (3GPP) will soon be developing standards for the PTT service.

However, it is very difficult to achieve good communication quality by providing the PTT service over a mobile communication network as illustrated in FIG. 1. In view of the nature of the air interface between a mobile station (MS) and a base station (BS), there are many problems to tackle. Accordingly, a more efficient PTT service is available by making modifications to existing mechanisms.

Referring to FIG. 1, the mobile communication network includes a MS 100, a BS 200, and a packet data service node (PDSN) 300. The PDSN 300 is connected to an Internet 400.

As previously mentioned, over-the-air transmission is a predominant consideration in providing the PTT service over the mobile communication network. The PTT service is deployed based on a protocol stack configured for data service. With the PTT service over the mobile communication network, a header attached in each Code Division Multiple Access (CDMA) layer results in a large overhead as well as a time delay during retransmission of data. Consequently, voice quality is degraded. Transmission over the air has a much higher error rate than wired transmission and thus frequent retransmissions result in degraded voice quality. Accordingly, the retransmission-incurred time delay may be irritating to PTT service users. Also, loading a header of each layer on a physical channel increases overhead, which may make it impossible to use a full rate CODEC. Therefore, while the PTT service follows a data flow, it must have the feature of a voice call made through conventional circuitry. Some discrepancy arises from the nature of the PTT service having a voice call feature and following the data flow. At present, when the PTT service is provided over a data network, the BS 200 has no way to determine that a certain call is for the PTT service. Hence, a real-time, error-insensitive PTT service cannot be achieved.

Since the BS 200 does not recognize a PTT call and the PTT service follows a general data service flow, the BS 200 may allocate a CDMA2000 1× Supplemental Channel (SCH). Moreover, the value of a dormant timer managed by a Packet Control Function (PCF) for managing the active/dormant state of an existing MS is very large, leading to the unnecessary allocation of a traffic channel. To overcome the problems, the BS 200 needs to be able to recognize a PTT call.

### SUMMARY OF THE INVENTION

An object of the present invention is to substantially solve at least the above problems and/or disadvantages and to provide at least the advantages below. Accordingly, an object of the present invention is to provide a newly defined service option in which the mobile station (MS) can indicate a Push-To-Talk (PTT) call as a voice call when initiating the PTT call in order to allow a base station (BS) to recognize the PTT call and thus to maintain voice quality after call setup.

Another object of the present invention is to provide a system and method of providing a PTT service for increasing the efficiency of the air interface in a mobile communication system.

The above objects are achieved by providing a system and method of providing a PTT service in a mobile communication system.

According to one aspect of the present invention, in a system and method of providing a PTT service to an MS in a BS in a mobile communication system wherein the BS provides a packet data service to the MS on a radio channel, the BS establishes a Radio Link Protocol (RLP) with the MS, upon receipt of an origination message including a service option for the PTT service from the MS, and establishes a Point-to-Point Protocol (PPP) session to provide the PTT service in packet data to the MS.

According to another aspect of the present invention, in a system and method of receiving a PTT service from a BS in an MS in a mobile communication system wherein the BS provides a packet data service to the MS on a radio channel, the MS transmits to the BS an origination message including a service option for the PTT service, is allocated to a fundamental channel by receiving a channel assignment message from the BS, and establishes a PPP session to receive the PTT service in packet data from the BS.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a conventional mobile communication network;

FIG. 2 is a diagram illustrating a signal flow between a mobile station (MS) and a base station (BS) to provide a Push-To-Talk (PTT) service in a mobile communication system according to an embodiment of the present invention; and

FIG. 3 is a flowchart illustrating an operation between the MS and the BS to provide the PTT service in the mobile communication system according to the embodiment of the present invention.

### DETAILED DESCRIPTION OF THE PREFERRED EMBODIMENT

An embodiment of the present invention will be described herein below with reference to the accompanying drawings. In the following description, well-known functions or constructions are not described in detail since they would obscure the invention in unnecessary detail.

In accordance with an embodiment of the present invention, to enable the base station (BS) 200 to recognize a Push-To-Talk (PTT) call, the mobile station (MS) 100 sets a new service option (SO) prior to a call setup. The service option will be described below with reference to a service option number format illustrated in Table 1.

TABLE 1
Service Option

| Proprietary | Service Option | Base Service |
|---|---|---|
| Indicator | Revision | Option Number |
| 1 bit | 3 bits | 12 bits |

Table 1 is a standard service option format that defines standard service option numbers. A service option number composes three fields: the 1-bit Proprietary Indicator field, the 3-bit Service Option Revision field, and 12-bit Base Service Option Number field. In the embodiment of the present invention, the 12-bit Base Service Option Number field indicates a PTT call between the MS 100 and the BS 200.

According to the standard service option format, multicall services such as video conferencing are set to S057, S058 and S059. S060 and S061 are given to header compression to provide Voice over Internet Protocol (VoIP) services over a communication network. Service options are also defined for facsimile and short message service (SMS). Since the service option format is 16 bits in size, it is sufficiently expandable.

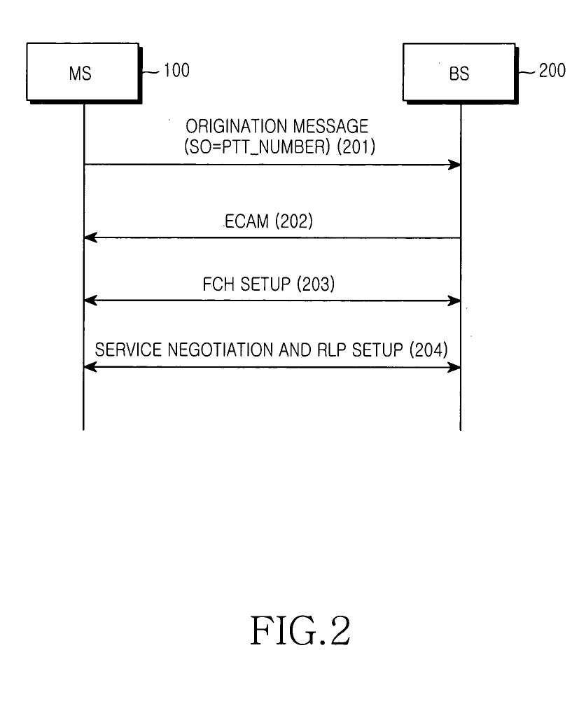

A PTT service providing method in the mobile communication system according to the embodiment of the present invention will be described with reference to FIG. 2. FIG. 2 is a diagram illustrating a signal flow for a control operation to provide the PTT service between an MS and a BS in the mobile communication system according to an embodiment of the present invention.

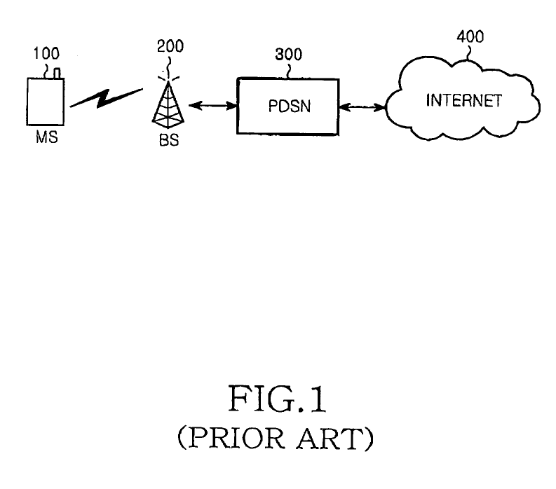

Referring to FIG. 1, when the MS 100 initially sets up a call, it sends to the BS 200 an Origination Message including the newly defined service option for the PTT service as illustrated in Table 1 in step 201. Upon receipt of the Origination Message, the BS 200 authenticates the MS 100 via a mobile switching center (MSC) (not shown) and allocates resources for the call. A path is then established between a base transceiver station (BTS) (not shown) and a base station controller (BSC) (not shown) in the BS 200. In step 202, the BS 200 sends an Enhanced Channel Assignment Message (ECAM) to the MS 100. It should be appreciated by those skilled in the art that the functions of the MS, BS, BSC and MSC can be performed via a MS module, BS module, BSC module and MSC module, respectively.

According to the ECAM, the MS 100 establishes a new fundamental channel in step 203. A Walsh code logically identifying the BS 200 is used for the FCH.

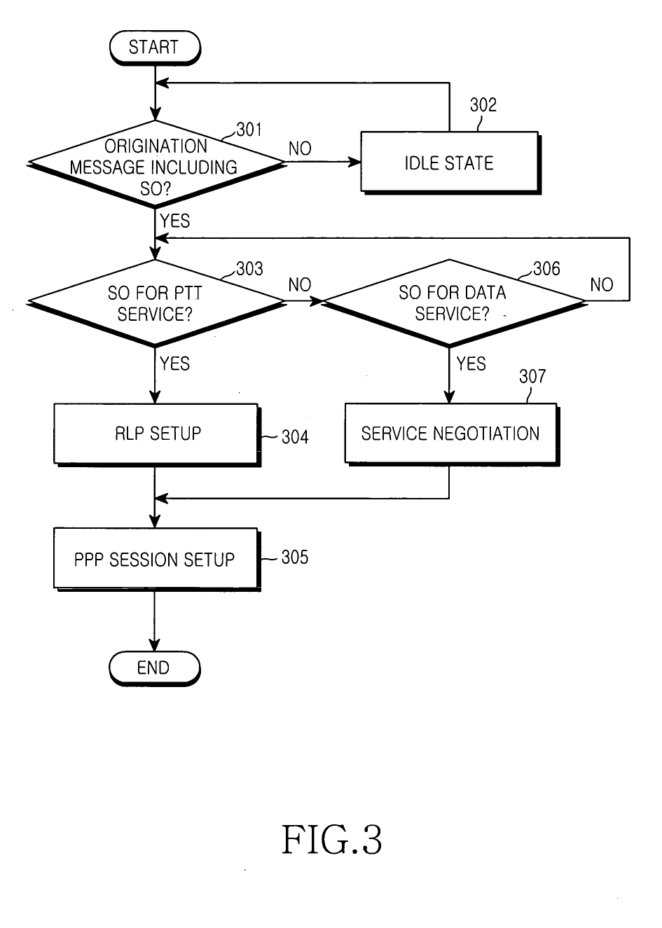

The MS 100 and the BS 200 negotiate for the PTT service including a Radio Link Protocol (RLP) setup in step 204. The RLP setup will be described in greater detail with reference to FIG. 3.

FIG. 3 is a flowchart illustrating an operation between the MS and the BS to provide the PTT service in the mobile communication system according to the embodiment of the present invention.

Referring to FIG. 3, the BS 200 determines whether the Origination Message including a service option number as illustrated in Table 1 has been received from the MS 100 in step 301. If the Origination Message has not been received yet, the BS 200 is kept in an idle state in step 302. Upon receipt of the Origination Message, the BS 200 determines whether the service option number indicates a service option for a PTT call in step 303. In the case of the service option for the PTT call, the BS 200 performs an RLP setup in step 304. Specifically, the BS 200 sets a binary large objects (BLOB) parameter that brings RLP characteristics unique to the PTT service. For a PTT call, NAK Round in the BLOB parameters is set to 0 or 1. If NAK Round is 0, the BS 200 operates in a transparent RLP mode with no retransmission and provides a voice service by RLP.

The RLP BLOB parameter has information about a round time and a NAK scheme. The information must be optimized for the PTT service. In step 305, a Point-to-Point Protocol (PPP) session is established for a PPP service call between the MS 100 and the PDSN 300.

However, if the service option number does not indicate the service option for the PTT service in step 303, the BS 200 determines whether the service option number indicates a service option for a data service call in step 306. In the case of the service option for the data service call, service negotiations are made between the MS 100 and the BS 200 in step 307 and the PPP session is established for the data service between the MS 100 and the PDSN 300 in step 305.

As described above, a new service option identifying the PTT service between the MS 100 and the BS 200 is defined to allow them to recognize a PTT call.

The embodiment of the present invention advantageously optimizes provisioning of the PTT service over a mobile communication network by defining a new PTT service option and thus allowing an MS and a BS to recognize a PTT call by the PTT service option.

While the invention has been shown and described with reference to a certain embodiment thereof, it should be understood by those skilled in the art that various changes in form and details may be made therein without departing from the spirit and scope of the invention as defined by the appended claims.

1. A method of providing a Push-to-Talk (PTT) service to a mobile station (MS) via a base station (BS) in a mobile communication system wherein the BS provides a packet data service to the MS on a radio channel, the method comprising the steps of:
establishing a radio link protocol (RLP) with the MS, upon receipt of an origination message including a service option for the PTT service from the MS; and
establishing a point-to-point protocol (PPP) session to provide the PTT service in packet data to the MS.

2. The method of claim 1, wherein the service option includes a Proprietary Indicator field, a Service Option Revision field, and a Base Option Number field.

3. The method of claim 2, wherein the Base Option Number field indicates a PTT call between the MS and the BS.

4. The method of claim 2, wherein the Proprietary Indicator field comprises 1 bit, the Service Option Revision field comprises 3 bits, and the Base Option Number field comprises 12 bits.

5. The method of claim 1, wherein the first step of establishing further comprises:
providing a Binary Large Objects Block (BLOB) parameter for a voice call for the PTT.

6. The method of claim 5, further comprising:
setting the BLOB parameter to either a one or a zero.

7. The method of claim 6, wherein the BS operates in a transparent mode when the BLOB parameter is set to a zero.

8. The method of claim 7, wherein the BS does not provide retransmissions with the voice service.

9. A method of receiving a Push-to-Talk (PTT) service from a base station (BS) in a mobile station (MS) in a mobile communication system wherein the BS provides a packet data service to the MS on a radio channel, the method comprising the steps of:
transmitting to the BS an origination message including a service option for the PTT service;
allocating the packet data service to a fundamental channel by receiving a channel assignment message from the BS; and
establishing a point-to-point protocol (PPP) session to receive the PTT service in packet data from the BS.

10. The method of claim 9, wherein the service option includes a Proprietary Indicator field, a Service Option Revision field, and a Base Option Number field.

11. The method of claim 10, wherein the Base Option Number field indicates a PTT call between the MS and the BS.

12. The method of claim 10, wherein the Proprietary Indicator field comprises 1 bit, the Service Option Revision field comprises 3 bits, and the Base Option Number field comprises 12 bits.

13. A system for providing voice based Push-to-Talk (PTT) service in a mobile communication system, comprising:
a mobile station (MS) module in a mobile station for receiving a packet data service on a radio channel; and
a base station (BS) module in a base station for establishing a radio link protocol (RLP) with the MS module, upon receipt of an origination message including a service option for the PTT service from the MS module, and establishing a point-to-point protocol (PPP) session to provide the PTT service in packet data to the MS module.

14. The system of claim 13, wherein the service option includes a Proprietary Indicator field, a Service Option Revision field, and a Base Option Number field.

15. The system of claim 14, wherein the Base Option Number field indicates a PTT call between the MS module and the BS module.

16. The system of claim 14, wherein the Proprietary Indicator field comprises 1 bit, the Service Option Revision field comprises 3 bits, and the Base Option Number field comprises 12 bits.

17. The system of claim 13, wherein the BS module provides a Binary Large Objects Block (BLOB) parameter for a voice call for the PTT.

18. The system of claim 17, wherein the BS module sets the BLOB parameter to either a one or a zero.

19. The system of claim 18, wherein the BS module operates in a transparent mode when the BLOB parameter is set to a zero.

20. The system of claim 19, wherein the BS module does not provide retransmissions with the voice service.

21. A modular network for providing voice based Push-to-Talk (PTT) service in a mobile communication system, comprising:
a mobile station (MS) module adapted to receive a packet data service on a radio channel; and
a base station (BS) module adapted to establish a radio link protocol (RLP) with the MS module, upon receipt of an origination message including a service option for the PTT service from the MS module, and establish a point-to-point protocol (PPP) session in order to provide the PTT service in packet data to the MS module.

22. The modular network of claim 21 wherein the mobile station module is disposed in a wireless terminal and the base station module is disposed in at least one of a base station and a mobile switching center.
